(19) United States
(12) Patent Application Publication
(10) Pub. No.: US 2004/0152473 A1
(43) Pub. Date: Aug. 5, 2004

(54) Mobile communication system, radio network controller, radio terminal, data delivering method, and program for the method

(75) Inventors: Hiroaki Kuwano, Tokyo (JP); Masahiko Kojima, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/747,958

(22) Filed: Dec. 31, 2003

(30) Foreign Application Priority Data
Jan. 10, 2003 (JP) 2003-004714

(51) Int. Cl. H04Q 7/20

(52) U.S. Cl. 455/456.2

(57) ABSTRACT

A radio network controller is provided which is capable of broadcasting MBMS data without transition of a UE to a CELL_DCH state or CELL_FACH state. A buffer is used for buffering the MBMS data received from a BMSC via a host device side interface unit, an MBMS data management unit divides the buffered MBMS data into pieces of each size transmittable and receivable between a Node B and the UE and determines delivering schedule information of the MBMS data. A schedule notifying unit notifies the UE of the delivering schedule information via a Node B interface unit by a paging massage or notice channel. An MBMS data transmitting unit transmits the MBMS data to the UE via the Node B interface unit using a FACH.

### BACKGROUND OF THE INVENTION

1. Field of the Invention

The present invention relates to a mobile communication system, a radio network controller, a radio terminal, a data delivering method for the mobile communication system, and a program for the method, and more particularly, to a mobile communication system capable of broadcasting the same service data to a plurality of radio terminals.

2. Description of the Related Art

A mobile communication system provides a service of broadcasting large amounts of the same content data including sounds and images to a plurality of radio terminals, which is referred to as an MBMS (Multimedia Broadcast Multicast Service) (e.g., see the Non-patent document 1).

FIG. 7 shows a configuration of a mobile communication system having such an MBMS function. As shown in FIG. 7, a BMSC (Broadcast Multicast Service Center) 31 is connected to an IP (Internet Protocol) network 100, as well as to a plurality of RNCs (Radio Network Controllers) 34, 35 via a GGSN [Gateway GPRS (General Packet Service) Support Node] 32 and an SGSN (Serving GPRS Support Node) 33.

The RNC 34 has Nodes B (radio base station) 36, 37 subordinate thereto, and the RNC 35 has a Node B 38 subordinate thereto. Each of the Nodes B 36 to 38 has one or more coverage areas of cells A to C. FIG. 7 shows here, for a simple description, that each of the Nodes B 36, 37, and 38 covers cells A, B, and C, respectively, and reference numeral 40 denotes a UE (User Equipment), which is a radio terminal.

An interface between the SGSN 33 and the RNC 34,35 is referred to as an Iu, and an interface between the RNC 34, 35 and the Nodes B 6 to 8 is referred to as an Iub. Also, an interface Iur resides between the RNCs 34 and 35.

When the UE 40 in FIG. 7 wishes to receive the above-described MBMS data, procedures shown in FIG. 8 are executed between the UE 40 and the BMSC 31. More specifically, a “subscription”, which is for asking to join the service, is sent from the UE 40 (c1 in FIG. 8) through the RNC 34 to the BMSC 31.

From the BMSC 31 “service announcement” for announcing the service is sent (c2 in FIG. 8), and in response thereto, “joining”, which is a service joining request, is sent from the UE 40 (c3 in FIG. 8). Then, “MBMS multicast mode bearer set up”, which is bearer setting for the MBMS, is executed by the BMSC 31 for the RNC 34 (c4 in FIG. 8).

Subsequently, the MBMS data is sent from the BMSC 31 to the RNC 34 (c5 in FIG. 8), followed by transmission of “MBMS notification” notifying of the MBMS delivering from the RNC 34 to the UE 40 (c6 in FIG. 8). The data is finally broadcast from the RNC 34 to the UE 40 (c7 in FIG. 8).

Upon the completion of broadcasting the whole data, “MBMS multicast mode bearer release”, which is for releasing the bearer, is sent from the BMSC 31 (c8 in FIG. 8), and “leaving” indicating withdrawal from the service is sent from the UE 40 (c9 in FIG. 8), and the processing comes to the end.

[Non-Patent Document 1]

TS22.146, version 6.1.0 (2002-09), Chapter 4, prepared by the 3GPP

The foregoing conventional mobile communication system, however, has the following disadvantage. When broadcasting of the MBMS data is started according to the above procedures, the UE must be transitioned once to a CELL_DCH (Dedicated Channel) state or CELL_FACH (Forward Access Channel) state on RRC (Radio Resource Control) in order to receive the MBMS data, because the UE transitions, after sending the “joining”, to a PCH (Paging Channel) wait state and then goes into an IDLE state, a CELL_PCH/URA_PCH state, or the like.

The DCH is a point-to-point bi-directional channel that is used for transmission of user data and is allocated dedicatedly to each UE, and is also capable of fast rate change and fast power control. The FACH is a downlink common channel that is used for transmission of control information and user data and is shared by a plurality of UEs, and is used to transmit data at a low rate from an upper layer.

The CELL_DCH state is as follows: A dedicated physical channel is allocated to the UE, and the UE continuously monitors the DCH. The CELL_FACH state is as follows: No dedicated physical channel is allocated to the UE, the UE receives in the downlink and continuously monitors the FACH, and the UE can use a common channel that is transmittable anytime in the uplink.

Furthermore, the CELL_PCH state is as follows: No dedicated physical channel is allocated to the UE, the UE receives the PCH using DRX (Discontinuous Reception) via a PICH (Paging Indication Channel), and no uplink activity is possible.

The aforementioned transition to the CELL_DCH state or the CELL_FACH state involves switching processing for this transition in each UE. Therefore, the presence or absence of need for switching processing or differences in switching time in individual UEs may disadvantageously cause time differences of the MBMS data delivering among the individual UEs.

The object of the present invention is, therefore, to overcome the foregoing problem, and to provide a mobile communication system capable of broadcasting MBMS data without transition of a UE to a CELL_DCH state or CELL_FACH state, and a radio network controller, a radio terminal, a data delivering method of the mobile communication system, and a program for the method.

### SUMMARY OF THE INVENTION

A first aspect of the present invention is directed to a mobile communication system broadcasting service data from a radio network controller to a radio terminal in response to a service joining request from the radio terminal, the service data corresponding to the service joining request, wherein the radio network controller comprises means for providing a delivering notice of the service data to the radio terminal by a paging message.

A second aspect of the present invention is directed to a radio network controller broadcasting service data to a radio terminal in response to a service joining request from the radio terminal, the service data corresponding to the service joining request, the radio network controller which comprises means for providing a delivering notice of the service data to the radio terminal by a paging massage.

A third aspect of the present invention is directed to a radio terminal receiving service data broadcast from a radio network controller in response to a service joining request issued from the own radio terminal, the service data corresponding to the service joining request, the radio terminal which comprises means for acquiring the service data in accordance with a delivering notice of the service data that is provided from the radio network controller by a paging massage.

A fourth aspect of the present invention is directed to a data delivering method for a mobile communication system broadcasting service data from a radio network controller to a radio terminal in response to a service joining request from the radio terminal, the service data corresponding to the service joining request, wherein the radio network controller executes a step of providing a delivering notice of the service data to the radio terminal by a paging massage.

A fifth aspect of the present invention is directed to a program of data delivering method for a mobile communication system broadcasting service data from a radio network controller to a radio terminal in response to a service joining request from the radio terminal, the service data corresponding to the service joining request, wherein the program causes the radio network controller to execute a step of providing a delivering notice of the service data to the radio terminal by a paging massage.

More specifically, according to a first mobile communication system of the present invention, an RNC (Radio Network Controller) notifies a UE (User Equipment: radio terminal) by a paging massage that MBMS (Multimedia Broadcast Multicast Service) data is distributed. Therefore, the UE, which has transitioned to a PCH (Paging Channel) wait state and is involved in an IDLE state or CELL_PCH/URA_PCH state, does not need to be transitioned to a CELL_DCH (Dedicated Channel) state or CELL_FACH (Forward Access Channel) state to achieve the broadcast delivering of the MBMS data.

That is, the UE can recognize timing of when the MBMS data is distributed, which allows the UE to simply acquire the MBMS data over the FACH, thus enabling the UE to receive and display the MBMS data without the need of transition to the CELL_DCH state or CELL_FACH state.

According to a second mobile communication system of the present invention, a delivering schedule of the MBMS data is notified by a paging massage before the actual delivering of the MBMS data. Therefore, the UE, which has transitioned to the PCH wait state and is involved in the IDLE state, does not need to be transitioned to the CELL_DCH state or CELL_FACH state to achieve the broadcast delivering of the MBMS data.

Furthermore, according to a third mobile communication system of the present invention, the paging massage is used to notify that notification information has been changed and a notice channel [BCCH (Broadcast control Channel), BCH (Broadcast Channel)] is used to notify that the MBMS data is distributed. Therefore, the UE, which has transitioned to the PCH wait state and is involved in the IDLE state, does not need to be transitioned to the CELL_DCH state or CELL_FACH state to achieve the broadcast of the MBMS data.

Moreover, according to a fourth mobile communication system of the present invention, a notification that the notification information has been changed is provided by a paging massage and a delivering schedule of the MBMS data is notified by the notice channel, before the actual delivering of the MBMS data. This eliminates the need of transition of the UE to the CELL_DCH state or CELL_FACH state to achieve the broadcast of the MBMS data, even when the UE has transitioned to the PCH wait state and is involved in the IDLE state.

In the foregoing first to fourth mobile communication systems of the present invention, a notification of either the MBMS data delivering notice or the delivering schedule of the MBMS data is provided, thereby allowing continuous delivering and discontinuous delivering of the MBMS data.

### BRIEF DESCRIPTION OF THE DRAWINGS

FIG. 1 is a block diagram showing a configuration of an RNC according to one embodiment of the present invention;

FIG. 2 is a block diagram showing a configuration of a UE according to the embodiment of the present invention;

FIG. 3 is a sequence chart showing a receiving procedure of MBMS data in a mobile communication system according to the embodiment of the present invention;

FIG. 4 is a sequence chart showing a receiving procedure of the MBMS data in a mobile communication system according to another embodiment of the present invention;

FIGS. 5A and 5B are tables exemplarily showing a broadcasting schedule of the MBMS according to the present invention;

FIG. 6 is a diagram showing an example of notifying timing of starting MBMS of a content (TMGI=a) according to the present invention;

FIG. 7 is a block diagram showing a configuration of a conventional mobile communication system; and

FIG. 8 is a sequence chart showing data delivering procedures of the conventional mobile communication system.

### DETAILED DESCRIPTION OF THE PREFERRED EMBODIMENTS

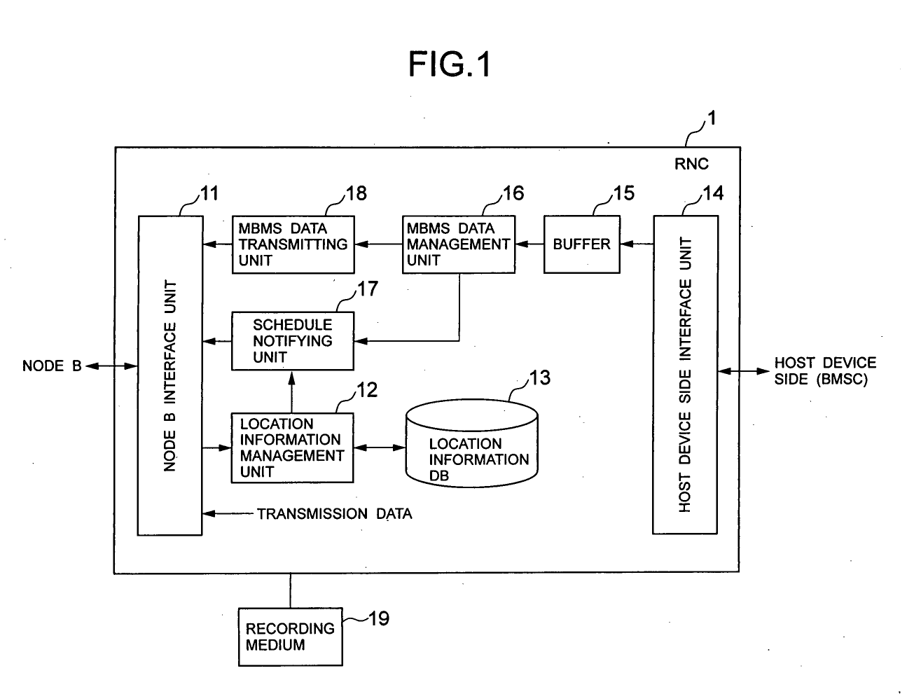

Embodiments of the present invention will be described with reference to the drawings. FIG. 1 is a block diagram showing a configuration of an RNC (Radio Network Controller) according to one embodiment of the present invention. As shown in FIG. 1, the RNC 1 comprises a Node B (radio base station) interface unit 11, a location information management unit 12, a location information database (DB) 13, a host device side interface unit 14, a buffer 15, an MBMS (Multimedia Broadcast Multicast Service) data management unit 16, a schedule notifying unit 17, an MBMS data transmitting unit 18, and a recording medium 19 storing a program (computer-executable program) for implementing operations of these units.

The Node B interface unit 11 is an interface operable for data transmission and reception with a Node B which is not shown. The location information management unit 12 manages location information received from a UE (User Equipment: radio terminal) via the Node B and the Node B interface unit 11, and stores the location information in the location information database 13 as well as notifies the schedule notifying unit 17 of the location information.

The host device side interface unit 14 is an interface operable for data transmission and reception with a host device [in this embodiment, BMSC Broadcast Multicast Service Center (not shown)] which is not shown. The buffer 15 buffers the MBMS data received from the BMSC via the host device side interface unit 14, and transfers the MBMS data to the MBMS data management unit 16.

The MBMS data management unit 16 divides the MBMS data buffered in the buffer 15 into pieces of each size transmittable and receivable between the Node B and the UE and then transfers those pieces to the MBMS data transmitting unit 18, and determines whether to deliver the MBMS data continuously or discontinuously to report delivering schedule information thus obtained to both the schedule notifying unit 17 and the MBMS data transmitting unit 18.

The schedule notifying unit 17 notifies the UE of the delivering schedule information received from the MBMS data management unit 16, via the Node B interface unit 11 by a paging massage using a PCH (Paging Channel), or by a notice channel [BCCH (Broadcast control Channel) or BCH (Broadcast Channel)].

The PCH is a common channel for the downlink that is used for transmission of a paging signal. The BCCH is a downlink channel that is used to notify of system control information, and the BCH is a common channel for the downlink that is used for transmission of notification information (system information, cell information, etc.), and is transmitted at a fixed rate.

The MBMS data transmitting unit 18 transmits the MBMS data pieces divided in the MBMS data management unit 16 to the UE via the Node B interface unit 11 using an FACH (Forward Access Channel), in accordance with the delivering schedule information received from the MBMS data management unit 16. The FACH is a common channel for the downlink that is used to transmit control information and user data and shared by a plurality of UEs, and is used for data transmission from an upper layer at a low rate, or the like.

The Node B interface unit 11 and the host device side interface unit 14 are responsible for general operations of data transmission/reception, however, such operations are not directly associated with the present invention, so the description therefor will be omitted.

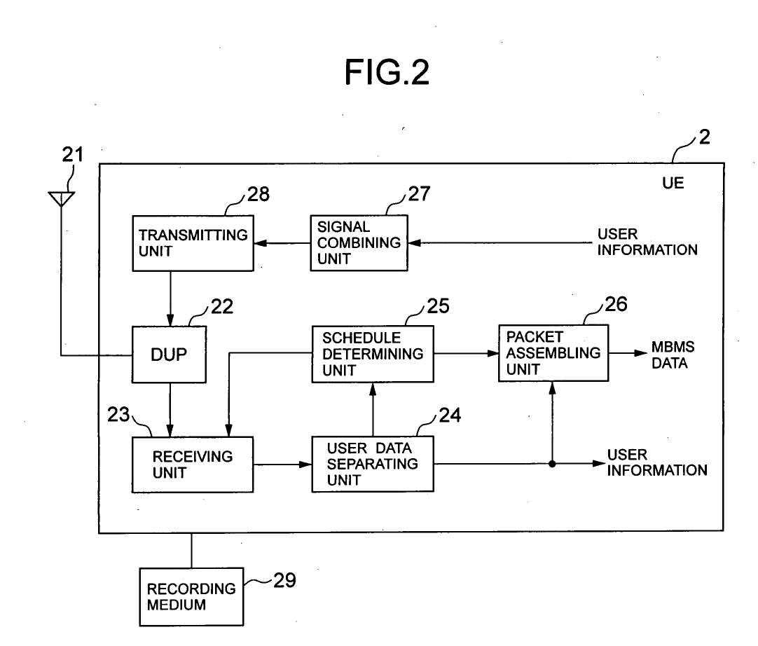

FIG. 2 is a block diagram showing a configuration of the UE according to the embodiment of the present invention. As shown in FIG. 2, the UE 2 comprises an antenna 21, a duplexer (DUP) 22, a receiving unit 23, a user data separating unit 24, a schedule determining unit 25, a packet assembling unit 26, a signal combining unit 27, a transmitting unit 28, and a recording medium 29 for storing a program (computer-executable program) for implementing operations of these units. Note here that, regarding a call control part, voice input/output part, and display part of the UE 2, publicly known arts are applicable thereto, so the descriptions of the configurations and operations for those parts will be omitted.

The receiving unit 23 sends to the user data separating unit 24, signals received via the antenna 21 and the duplexer 22 which include a CPICH (Common Pilot Channel), a DPCH (Dedicated Physical Channel) (DL: Downlink), and an HS-PDSCH (High Speed Physical Downlink Shared Channel).

The user data separating unit 24 separates the signals received from the receiving unit 23 into user information (voice signals, image signals, etc.) and control information, to thereby send the user information to each of the above described call control part, voice output part, display part and packet assembling unit 26 in the mobile station 2 and also to send the control information to the schedule determining unit 25.

Upon notification of either the MBMS data delivering notice or the delivering schedule of the MBMS data from the RNC 1 by the paging massage or notice channel, the schedule determining unit 25 notifies the receiving unit 23 and the packet assembling unit 26 of the notified information.

In accordance with the notified information from the schedule determining unit 25, the packet assembling unit 26 assembles user information obtained in response to the notification from the schedule determining unit 25 into the MBMS data, among the user information received by the receiving unit 23 and then separated in the user data separating unit 24. The packet assembling unit 26 then stores the resultant MBMS data in a memory which is not shown, and displays it onto a display unit.

The signal combining unit 27 combines together input signals from the outside coming into the call control part or voice input part in the UE 2, and transmits the resultant signals as a DPCH (UL: Uplink) or an HS-DPCCH via the transmitting unit 28 and the duplexer 22 from the antenna 21.

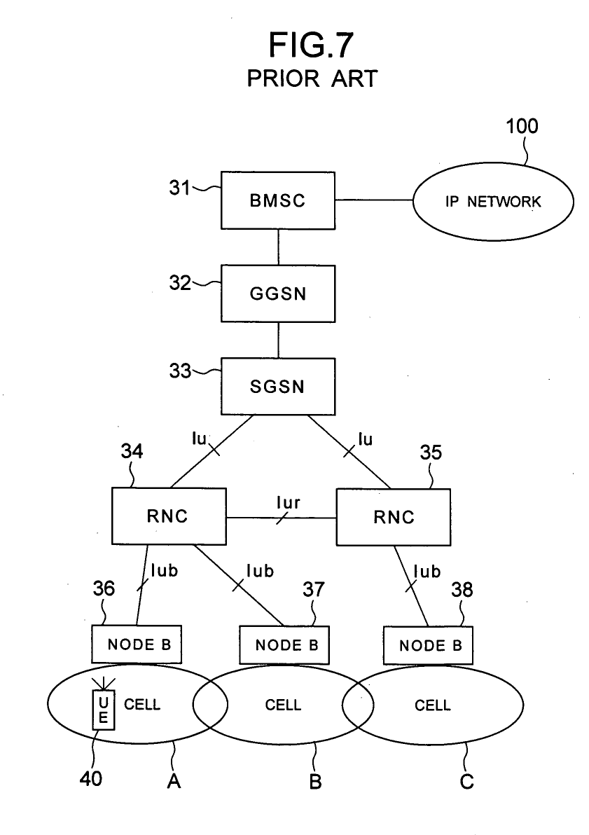

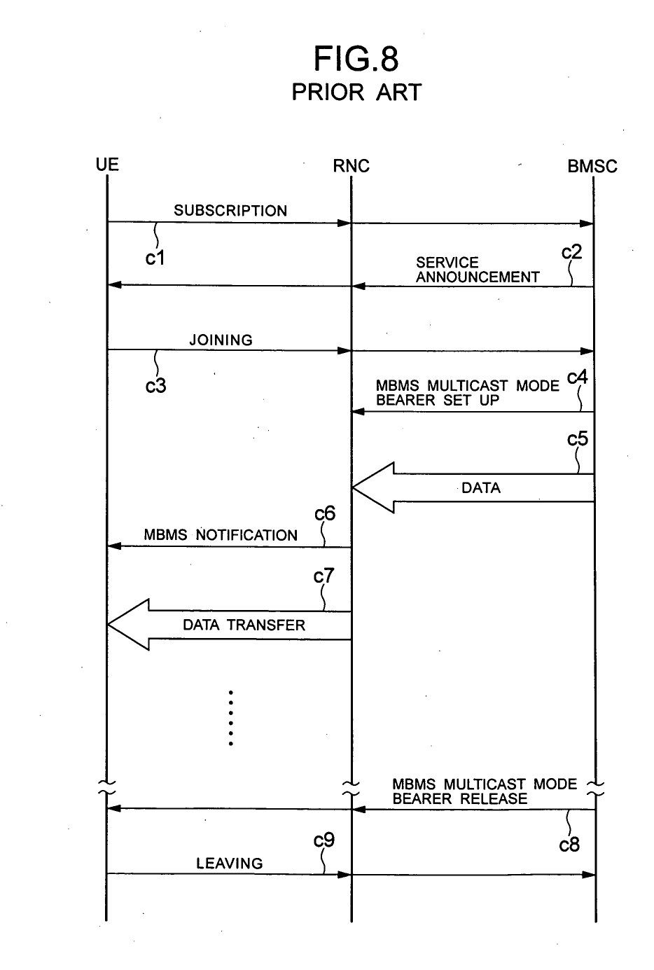

The mobile communication system herein according to the embodiment which includes the RNC 1 and the UE 2 has the same configuration as the conventional one shown in FIG. 7, therefore the basic procedures to acquire the MBMS data are also the same as those shown in FIG. 8.

However, the mobile communication system according to the embodiment of the present invention differs from the conventional system in that, in the case where the UE 2 has transitioned to a PCH wait state after sending the “joining” and is consequently involved in an IDLE state or CELL_PCH/URA_PCH state, if the UE 2 is provided with the MBMS data delivering notice or the delivering schedule of the MBMS data by the PCH or notice channel, the UE 2 can acquire the MBMS data distributed by the FACH on the basis of the delivering notice or the delivering schedule, without transition of the UE 2 to a CELL_FACH state.

The DCH is a point-to-point bi-directional channel that is used for transmission of user data and allocated dedicatedly to each UE, and is also capable of fast rate change and fast power control. The FACH is a downlink common channel that is used for transmission of control information and user data and shared by a plurality of UEs, and is used to transmit data from an upper layer at a low rate.

The CELL_DCH state is as follows: A dedicated physical channel is allocated to the UE, and the UE continuously monitors the DCH (downlink common channel). The CELL_FACH state is as follows: No dedicated physical channel is allocated to the UE, the UE receives in the downlink and continuously monitors the FACH (downlink common channel), and the UE can use a common channel that is transmittable anytime in the uplink.

The CELL_PCH/URA_PCH state is as follows: No dedicated physical channel is allocated to the UE, the UE receives the PCH using DRX (Discontinuous Reception) via a PICH (Paging Indication Channel), and no uplink activity is possible.

Thus, in this embodiment, when the UE 2 is provided with the MBMS data delivering notice or the delivering schedule of the MBMS data from the RNC 1 by the PCH or notice channel, the UE 2 may acquire selectively data over the FACH in accordance with the notification without the need of transition to the CELL_FACH state, so that the UE 2 can receive the broadcast delivering of the MBMS data without the need of temporal transition to the CELL_DCH state or CELL_FACH state. This consequently eliminates the time difference of the MBMS data delivering between the UE 2 and other UEs which is generated due to the presence or absence of need for switching processing or the difference in switching time among the individual UEs.

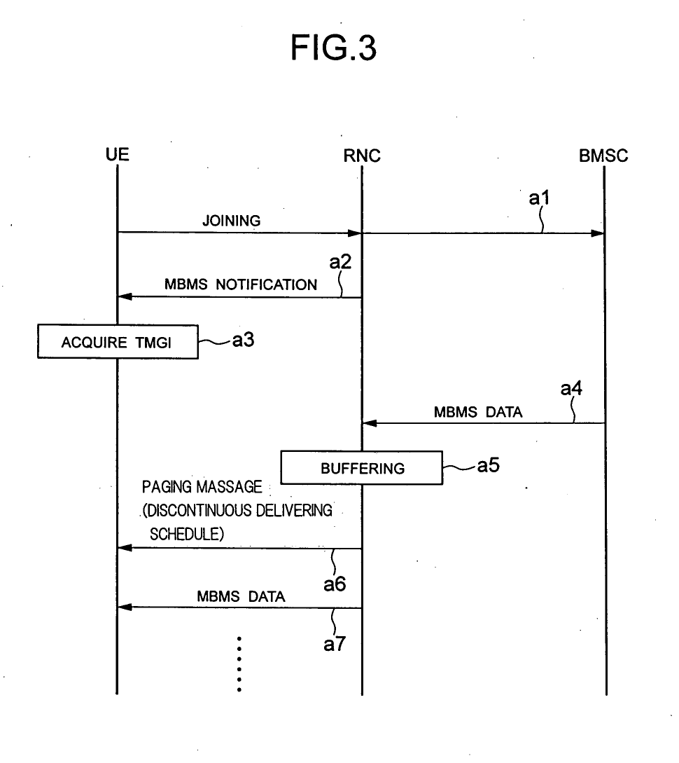

FIG. 3 is a sequence chart showing a receiving procedure of the MBMS data in the mobile communication system according to the embodiment of the present invention. Referring to FIGS. 1 to 3, the description will be made for the receiving procedure of the MBMS data in the mobile communication system according to the embodiment of the present invention. The operations shown in FIG. 3 are realized when both the RNC 1 and the UE 2 execute each program in the recording media 19, 29, respectively.

Upon receipt of the MBMS data in an RRC (Radio Resource Control) IDEL state (CELL_PCH state), the UE 2 acquires and stores a TMGI (Temporary Mobile Group Identity) for contents the UE 2 has joined, along a joining procedure (a1, a2, and a3 in FIG. 3).

Subsequently to the joining procedure, the UE 2 releases the RRC connection, or when the UE 2 is in a multicall state with PS (Packet Switched) (Best Effort), it goes to the CELL_PCH state or further goes to the IDLE state under the initiative of the RNC 1 induced by reduced PS RAB (Radio Access Bearer) traffic.

Upon receipt of the MBMS data from the BMSC, the RNC 1 buffers the MBMS data in the buffer 15 (a4 and a5 in FIG. 3) and recognizes a state of the UE 2 on the RRC. When the UE 2 is in the IDLE state (CELL_PCH state), the RNC 1 provides the UE 2 with the MBMS data delivering notice or the delivering schedule of the MBMS data using the paging massage by the PCH, without establishing a RB (Radio Bearer) of the MBMS (a6 FIG. 3).

The RNC 1 provides the MBMS service to the UE 2 by distributing the MBMS data by the FACH in accordance with the information provided to the UE 2 using the paging massage (a7 in FIG. 3). The above description has dealt with the case in which the RNC 1 provides the MBMS service to the UE 2, wherein the RNC 1 is basically broadcasting the MBMS data. This means that other UEs are also “Joining”.

Thus, in this embodiment, either the delivering notice of the MBMS data or the delivering schedule of the MBMS data is provided from the RNC 1 by the PCH, and the UE 2 may therefore acquire selectively data over the FACH in accordance with the provided information without transition of the UE 2 to the CELL_FACH state. The MBMS data can thus be broadcast without the need of transition of the UE 2 to the CELL_DCH state or CELL_FACH state.

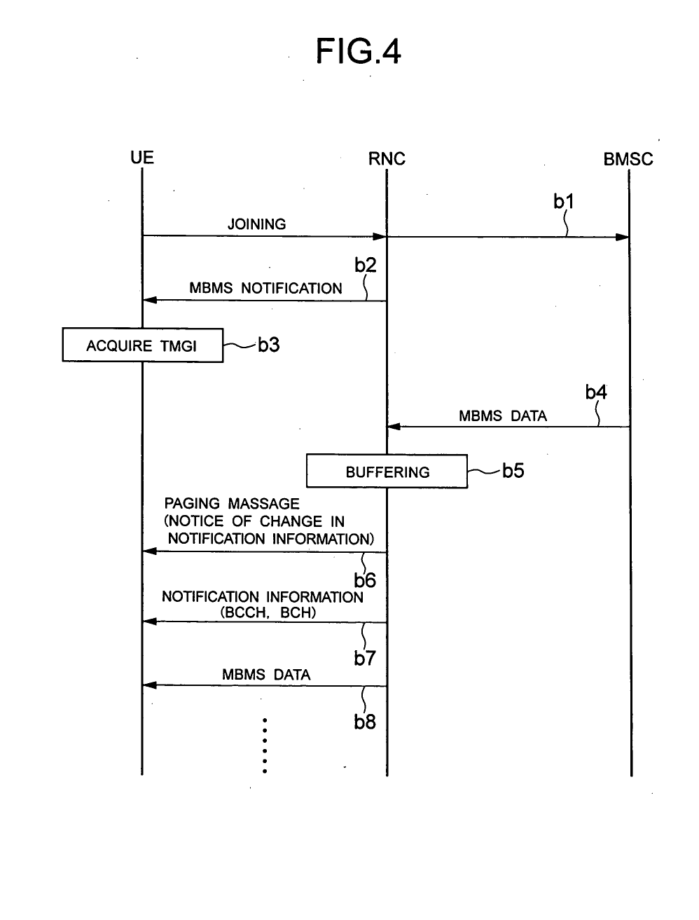

FIG. 4 is a sequence chart showing a receiving procedure of the MBMS data in a mobile communication system according to another embodiment of the present invention. The mobile communication system according to another embodiment of the present invention is realized by employing the RNC 1 of FIG. 1 and the UE 2 of FIG. 2 in the conventional mobile communication system of FIG. 8. Therefore, the description will be made referring to FIGS. 1, 2, and 4 for the receiving procedure of the MBMS data in the mobile communication system according to another embodiment of the present invention. The operations shown in FIG. 4 are implemented when both the RNC 1 and the UE 2 execute each program of the recording media 19, 29, respectively.

When the UE 2 is in the IDLE state or in the CELL_PCH/URA_PCH state, it needs to check a PICH (Paging Indication Channel) for paging with predetermined timing. At the timing of this operation, the UE 2 cannot receive the MBMS data (during reception of paging, maximum twice for PICH and PCH (SFN: Serial Frame Number).

Therefore, the RNC 1 needs to avoid the paging timing of the UE 2 in order to transmit the MBMS data, and also needs to notify the UE 2 beforehand of the transmission timing (scheduling information) of the MBMS in the notification information.

When the UE 2 receives the MBMS data in the IDLE state or the CELL_PCH/URA_PCH state on the RRC, the UE 2 acquires and stores the TMGI for the content the UE 2 has joined in the joining procedure (b1, b2, and b3 in FIG. 4).

After the joining procedure, the UE 2 releases the RRC connection, or when the UE 2 is in the PS (Best Effort) multicall state, it goes to the PCH state or further goes to the IDLE state under the initiative of the RNC 1 induced by reduced the RAB traffic.

Upon receipt of the MBMS data from the BMSC, the RNC 1 buffers the MBMS data in the buffer 15 (b4 and b5 in FIG. 4), and recognizes the RRC state of the UE 2. When the UE 2 is in the IDLE state or CELL_PCH/URA_PCH state, the RNC 1 notifies the UE 2 using the paging massage by the PCH that the notification information has been changed (b6 in FIG. 4), and also provides the UE 2 with either the MBMS data delivering notice or the MBMS data delivering schedule by the notice channel (BCCH, BCH) (b7 in FIG. 4).

The RNC 1 provides the MBMS service by distributing the MBMS data by the FACH in accordance with information provided to the UE 2 by the notice channel (b8 in FIG. 4). The above description has dealt with the case in which the RNC 1 provides the MBMS service to the UE 2, wherein the RNC 1 is basically broadcasting the MBMS data. This means that other UEs are also “Joining”.

Thus, in this embodiment, either the MBMS data delivering notice or the MBMS data delivering schedule is provided from the RNC 1 by the notice channel, and the UE 2 may therefore acquire selectively data over the FACH in accordance with the provided information without transition of the UE 2 to the CELL_FACH state. The MBMS data can thus be broadcast without the need of transition of the UE 2 to the CELL_DCH state or CELL_FACH state.

In the case of transfer of the MBMS transmission timing (scheduling information) by the notice channel, the UE, which is in the CELL_DCH state or CELL_FACH state, is not able to see this notification information. Therefore, as a substitute therefor, a UTRAN (Universal Terrestrial Radio Access Network) notifies each UE by the RRC massage over a DCCH (Dedicated Control Channel), or MBMS transmission is performed independently for both IDLE PCH and FACH/DCH (since FACH delivering is not applicable to DCH user, DCH is used).

The paging timing comes once in every DRX (Discontinuous Reception) Cycle (with all UEs, timing comes at least once, although all different), and the MBMS data cannot be transmitted/received in the associated SFNs. This prevents users in the IDLE or PCH state from receiving the discontinuous delivering of the MBMS data, disadvantageously leading to a reduction in throughput of the UE.

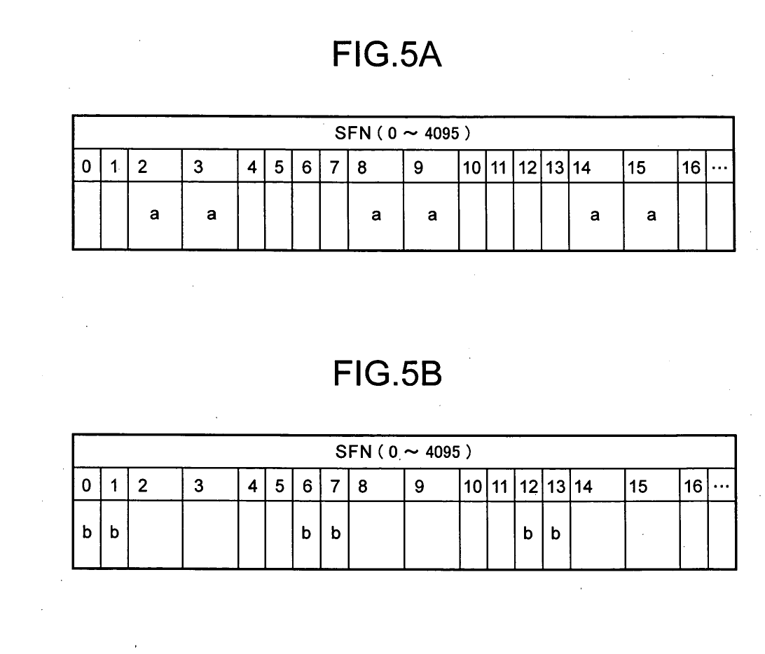

FIGS. 5A and 5B are tables exemplarily showing an MBMS data broadcasting schedule according to the present invention. Referring to FIGS. 5A and 5B, a technique of transmission timing for the MBMS will be described.

In order to allow the MBMS transmission/reception of the UE when it is in the IDLE state or CELL_PCH/URA_PCH state on the RRC, RLC (Radio Link Control) must be UM (Unacknowledged Mode: Unacknowledged data transfer), but not be AM (Acknowledged Mode: Acknowledge data transfer). There is thus no UL (Uplink) RRC massage.

The paging is executed once for every DRX Cycle and the paging timing is different for every UE, which means that there exists no SFN in which all UEs are not involved in the timing of paging (including PICH). Therefore, the UTRAN is required to deliver the same MBMS data at least twice (three times when consideration is given to both PICH and PCH).

For example, a specific UE (UE#A) needs to check the paging with timing of SFN=0, 128, 256, . . . , where the MBMS data is transmitted in SFN=1. However, another UE (UE#B) may possibly be receiving with timing of SFN=1, 129, 257, . . . , therefore the UE#A may fail to receive the MBMS data.

Accordingly, assuming that an integer of radio frames in an TTI (Transmission Time Interval) of FACH allocated for MBMS is Mtti, MBMS allocation frequency cycle in SCCPCH (Secondary Common Control Physical Channel), which is an integer N of the radio frames, is calculated by:

N=Mtti×m(integer)

and an integer number K in MBMS frame offset is calculated by:

K=Mtti×n(integer)

Note here that a Logical CH for IDLE or PCH users is XTCH which is transferred over the FACH or SCCPCH.

When the cell has three types of contents, and in one content (TMGI=a), N is 6, K is 2, and Mtti is 2, the MBMS transmission timing is determined by:

SFN=N×p(integer)+K,

and subsequently only Mtti is continued:

1st time (p=0) . . . SFN=2, 3

2nd time (p=1) . . . SFN=8, 9

:

683rd time (p=682) . . . SFN=4094, 4095

684th time (p=683) . . . SFN=4, 5

(see FIG. 5A)

Next, when N is 6, K is 0, and Mtti is 2 in another content (TMGI=b), the MBMS transmission timing is determined by:

SFN=N×p(integer)+K

and subsequently only MTTi will be continued:

1st time (p=0) . . . SFN=0, 1

2nd time (p=1) . . . SFN=6, 7

:

683rd time (p=682) . . . SFN=4092, 4093

684th time (p=683) . . . SFN=2, 3

(see FIG. 5B)

In the above example, as the SFNs involved in the MBMS delivering are different between the first time and the second time, the UE needs to be notified by a NW side that the MBMS is started. This is because the notification for starting the MBMS is provided, as is described above.

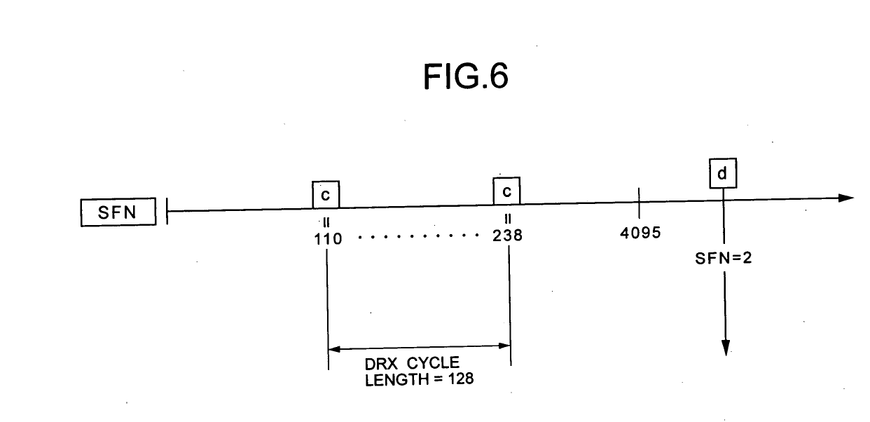

FIG. 6 is a diagram exemplarily showing that the MBMS starting timing is notified regarding the content (TMGI=a) according to the present invention. In FIG. 6, during a period of SFN=100 to 238 (DRX Cycle Length=128) before the first time (p=0) (c-c in FIG. 6), the RNC notifies the UE using RRC: Paging Type 1 (Notification) that the MBMS for TMGI=a is started from SFN=2. In this case, this notification is provided to all the UEs in one DRX Cycle Length.

Subsequently, the MBMS data of TMGI=a is distributed from SNF=2 (d in FIG. 6). Delivering scheduling of the MBMS data is determined depending on N, K and Mtti of the notification information. The Paging Type 1 (MBMS Notification) may periodically be provided, assuming that another UE will come into this cell later on.

In each of the foregoing embodiments of the present invention, data delivering is performed for each content (TMGI) in the FACH on a time division basis, and the same data is distributed several times on the supposition that the delivering timing conflicts with the paging timing (SFN unit). This inevitably yields a throughput lower than FACH, and when the number of repetitive times of delivering is twice, the throughput may result in half of FACH even at maximum.

To resolve this problem, this embodiment defines the SCCPCH which exists in the plural number within the same cell and contains on a content-by-content basis. For example,

SCCPCH#1: FACH for DTCH/DCCH/CCCH

SCCPCH#2: FACH for xTCH [not for IDLE and PCH users (intended for FACH state): Content#A]

SCCPCH#3: FACH for XTCH [not for IDLE and PCH users (intended for FACH state): Content#A]

SCCPCH#4: FACH for xTCH [not for IDLE and PCH users (intended for to FACH state): Content#B]

SCCPCH#5: FACH for xTCH [intended for IDLE and PCH users (not for FACH state): Content#A]

SCCPCH#6: FACH for xTCH [intended for IDLE and PCH users (not for FACH state): Content#A]

SCCPCH#7: FACH for xTCH [intended for IDLE and PCH users (not for FACH state): Content#B]

SCCPCH#8: PCH for PCCH, FACH for CTCH

The UE is notified beforehand by the notification information, of a type of content, an associated RRC state, and relevant FACH of SCCPCH. The SCCPCH#2, 3, and SCCPCH#5, 6 deliver data different from each other, and the data is divided and assembled at upper levels to achieve the enhancement of the throughput.

As described above, in the mobile communication system that in response to the service joining request from the radio terminal, broadcasts the service data corresponding to the service joining request from the radio network controller to the radio terminal, a notification that the service data is distributed is provided from the radio network controller to the radio terminal using the paging massage. Accordingly, this eliminates the need of transition of the UE to the CELL_DCH state or CELL_FACH state, so that the broadcasting of the MBMS data can effectively be achieved.

What is claimed is:

1. A mobile communication system broadcasting service data from a radio network controller to a radio terminal in response to a service joining request from the radio terminal, the service data corresponding to the service joining request, wherein
the radio network controller comprises means for providing a delivering notice of the service data to the radio terminal by a paging massage.

2. The mobile communication system according to claim 1, wherein the means for providing the service data delivering notice notifies the radio terminal by the paging massage that notification information for the radio terminal has been changed, and provides the service data delivering notice to the radio terminal in the notification information.

3. The mobile communication system according to claim 1, wherein the means for providing the service data delivering notice notifies the radio terminal of a delivering schedule of the service data by the paging massage.

4. The mobile communication system according to claim 1, wherein the means for providing the service data delivering notice notifies the radio terminal by the paging massage that the notification information for the radio terminal has been changed, and notifies the radio terminal of the delivering schedule of the service data in the notification information.

5. The mobile communication system according to claim 1, wherein the radio terminal comprises means for acquiring the service data in a PICH (Paging Indication Channel) receivable state in accordance with information provided by the radio network controller.

6. The mobile communication system according to claim 1, wherein the service data is distributed in at least one of a continuous manner and a discontinuous manner, from the radio network controller to the radio terminal.

7. The mobile communication system according to claim 1, wherein the service data includes MBMS (Multimedia Broadcast Multicast Service) data.

8. A radio network controller broadcasting service data to a radio terminal in response to a service joining request from the radio terminal, the service data corresponding to the service joining request, the radio network controller comprising:
means for providing a delivering notice of the service data to the radio terminal by a paging massage.

9. The radio network controller according to claim 8, wherein the means for providing the service data delivering notice notifies the radio terminal by the paging massage that notification information for the radio terminal has been changed, and provides the service data delivering notice to the radio terminal in the notification information.

10. The radio network controller according to claim 8, wherein the means for providing the service data delivering notice notifies the radio terminal of a delivering schedule of the service data by the paging massage.

11. The radio network controller according to claim 8, wherein the means for providing the service data delivering notice notifies the radio terminal by the paging massage that the notification information for the radio terminal has been changed, and notifies the radio terminal of the delivering schedule of the service data in the notification information.

12. The radio network controller according to claim 8, wherein the radio terminal acquires the service data in a PICH (Paging Indication Channel) receivable state in accordance with information provided by the means for providing the service data delivering notice.

13. The radio network controller according to claim 8, wherein the service data is distributed to the radio terminal in at least one of a continuous manner and a discontinuous manner.

14. The radio network controller according to claim 8, wherein the service data includes MBMS (Multimedia Broadcast Multicast Service) data.

15. A radio terminal receiving service data broadcast from a radio network controller in response to a service joining request issued by the own radio terminal, the service data corresponding to the service joining request, the radio terminal comprising:
means for acquiring the service data in accordance with a delivering notice of the service data that is provided by the radio network controller by a paging massage.

16. The radio terminal according to claim 15, wherein, upon notification by the paging massage that notification information for the own radio terminal has been changed, the service data delivering notice is received with the notification information.

17. The radio terminal according to claim 15, wherein, upon receipt of a delivering schedule of the service data notified by the paging massage, the service data is acquired in accordance with the delivering schedule.

18. The radio terminal according to claim 15, wherein, upon notification by the paging massage that the notification information for the own radio terminal has been changed, and further receipt of the delivering schedule of the service data with the notification information, the service data is acquired in accordance with the delivering schedule.

19. The radio terminal according to claim 15, wherein the service data is acquired in a PICH (Paging Indication Channel) receivable state in accordance with information provided by the radio network controller.

20. The radio terminal according to claim 15, where in the service data is distributed from the radio network controller in at least one of a continuous manner or a discontinuous manner.

21. The radio terminal according to claim 15, wherein the service data includes MBMS (Multimedia Broadcast Multicast Service) data.

22. A data delivering method for a mobile communication system broadcasting service data from a radio network controller to a radio terminal in response to a service joining request from the radio terminal, the service data corresponding to the service joining request, wherein
the radio network controller executes a step of providing a delivering notice of the service data to the radio terminal by a paging massage.

23. The data delivering method according to claim 22, wherein the step of providing the service data delivering notice includes notifying the radio terminal by the paging massage that notification information for the radio terminal has been changed, and providing the service data delivering notice to the radio terminal in the broadcast information.

24. The data delivering method according to claim 22, wherein the step of providing the service data delivering notice includes notifying the radio terminal of a delivering schedule of the service data by the paging massage.

25. The data delivering method according to claim 22, wherein the step of providing the service data delivering notice includes notifying the radio terminal by the paging massage that the notification information for the radio terminal has been changed, and notifying the radio terminal of the delivering schedule of the service data in the notification information.

26. data delivering method according to claim 22, wherein the radio terminal executes a step of acquiring the service data in a PICH (Paging Indication Channel) receivable state in accordance with information provided by the radio network controller.

27. The data delivering method according to claim 22, wherein the service data is distributed from the radio network controller to the radio terminal in at least one of a continuous manner and a discontinuous manner.

28. The data delivering method according to claim 22, wherein the service data includes MBMS (Multimedia Broadcast Multicast Service) data.

29. A program of data delivering method for a mobile communication system broadcasting service data from a radio network controller to a radio terminal in response to a service joining request from the radio terminal, the service data corresponding to the service joining request, wherein the program causes the radio network controller to execute the step of:
providing a delivering notice of the service data to the radio terminal by a paging massage.
